(19) United States
(12) Patent Application Publication
(10) Pub. No.: US 2026/0369903 A1
(43) Pub. Date: Nov. 19, 2026

(54) CONNECTOR

(71) Applicant: YAZAKI CORPORATION, Tokyo (JP)

(72) Inventors: Shintaro Yagi, Makinohara-shi (JP); Yoshitaka Suzuki, Makinohara-shi (JP)

(21) Appl. No.: 19/649,839

(22) Filed: Apr. 16, 2026

(30) Foreign Application Priority Data
May 13, 2025 (JP) 2025-080213

(51) Int. Cl. H01R 9/22

(52) U.S. Cl. CPC H01R 9/223

(57) ABSTRACT

A connector includes: a housing that includes a base portion having an end surface facing a first side in a first direction, and an insertion portion that protrudes from the base portion to the first side in the first direction and is configured to be inserted into a connection opening formed in a connection destination member; one or more terminals that are held by the housing; a front holder that has an insertion hole into which the insertion portion is inserted, and is attached to the insertion portion; and a packing that has an insertion opening into which the insertion portion is inserted, is disposed between the end surface and the front holder, and is in contact with an inner peripheral surface of the connection opening over an entire circumference in a circumferential direction.

### BACKGROUND OF THE INVENTION

### Field of the Invention

An embodiment of the present invention relates to a connector.

Priority is claimed on Japanese Patent Application No. 2025-080213 filed in Japan on May 13, 2025, the content of which is incorporated herein by reference.

### Description of Related Art

There has been known a connector in which a packing is interposed between a housing of a connector and a connection opening formed at a connection destination of the connector and into which the housing is inserted, thereby improving water-blocking performance between the housing of the connector and the connection opening.

### CITATION LIST

### Patent Document

Patent Document 1: Japanese Unexamined Patent Application, First Publication No. 2020-21644

Even when positions of the connector and the connection destination are displaced relative to each other, the connector is desired to maintain water-blocking performance.

One embodiment provides a connector capable of maintaining water-blocking performance even when positions of the connector and a connection destination member are displaced relative to each other.

### SUMMARY OF THE INVENTION

A connector of one embodiment includes: a housing that includes a base portion having an end surface facing a first side in a first direction, and an insertion portion that protrudes from the base portion to the first side in the first direction and is configured to be inserted into a connection opening formed in a connection destination member; one or more terminals that are held by the housing; a front holder that has an insertion hole into which the insertion portion is inserted, and is attached to the insertion portion at a position away from the end surface on the first side in the first direction; and a packing that has an insertion opening into which the insertion portion is inserted, is disposed between the end surface and the front holder, and is in contact with an inner peripheral surface of the connection opening over an entire circumference in a circumferential direction of the packing, wherein an opening dimension of the insertion opening in an intersecting direction intersecting the first direction is larger than an outer dimension, at a position facing the insertion opening in the first direction, of the insertion portion in the intersecting direction.

According to one embodiment, it is possible to maintain water-blocking performance even when positions of the connector and the connection destination member are displaced relative to each other.

### BRIEF DESCRIPTION OF THE DRAWINGS

FIG. 1 is a perspective view of a connector according to an embodiment and a connection destination member 7 when viewed from a second side in a first direction;

FIG. 2 is a perspective view of the connector according to the embodiment when viewed from a first side in the first direction;

FIG. 3 is a perspective view of a housing of the connector according to the embodiment when viewed from the first side in the first direction;

FIG. 4 is a view of the connector according to the embodiment when viewed from a second direction;

FIG. 5 is a cross-sectional view taken along line V-V in FIG. 4;

FIG. 6 is a perspective view of a front holder according to the embodiment when viewed from the first side in the first direction; and

FIG. 7 is a perspective view of a packing according to the embodiment when viewed from the first side in the first direction.

### DETAILED DESCRIPTION OF THE INVENTION

Hereinafter, an embodiment will be described with reference to the drawings. In the following description, constitutions having the same or similar functions are denoted by the same reference signs. Redundant descriptions of these constitutions may be omitted. Note that the constitutions described below do not limit the scope of the embodiment.

In the present disclosure, terms are defined as follows. A term “connection” is not limited to a mechanical connection, and may include an electrical connection. That is, the term “connection” is not limited to a case where two elements that are connection targets are directly connected, and may include a case where two elements that are connection targets are connected with another element interposed therebetween. A term “orthogonal” may include a case of “substantially orthogonal”.

In the present disclosure, a first direction D1, a second direction D2 (an intersecting direction), and a third direction D3 (an intersecting direction) are defined as follows. The first direction D1 is an insertion/removal direction of a connector and a connection destination member 7 to be described later. A first side D1a in the first direction D1 is a direction from a base portion 22 of a housing 2 of a connector 1 toward an insertion portion 23 in the first direction D1. A second side D1b in the first direction D1 is a direction from the insertion portion 23 toward the base portion 22. The second direction D2 is a direction intersecting (for example, orthogonal to) the first direction D1. The third direction D3 is a direction intersecting (for example, orthogonal to) the first direction D1 and the second direction D2.

### EMBODIMENT

### 1. Structure of Connector

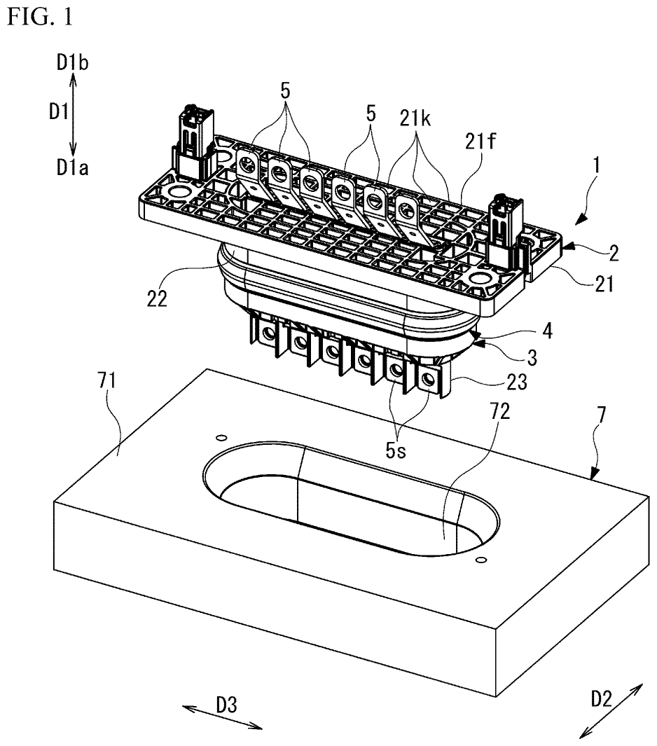

FIG. 1 is a perspective view of the connector according to the embodiment and the connection destination member 7 when viewed from a second side in the first direction.

The connector 1 illustrated in FIG. 1 is connected to, for example, an in-vehicle device mounted on a vehicle such as an electric vehicle (EV), a hybrid electric vehicle (HEV), or a plug-in hybrid electric vehicle (PHEV).

The connector 1 can be inserted into and removed from the connection destination member 7 along the first direction D1. In the present embodiment, the connection destination member 7 has a connection opening 72 extending from a connection surface 71 facing the other side D1b in the first direction D1 in the connection destination member 7 to the first side D1a in the first direction D1. The connection opening 72 is formed in an obround shape with the second direction D2 as a minor axis direction and the third direction D3 as a major axis direction when viewed from the first direction D1. Note that a shape of the connection opening 72 when viewed from the first direction D1 is not limited to the obround shape, and may be a circular shape, an oval shape, a polygonal shape, or the like. The connection destination member 7 is provided in a connection destination connector (not illustrated) to which the connector 1 is connected.

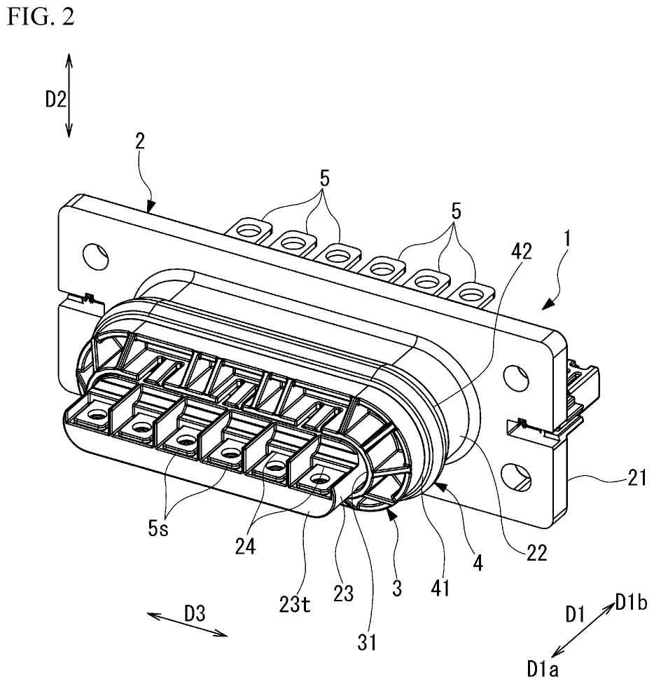

FIG. 2 is a perspective view of the connector according to the embodiment when viewed from the first side in the first direction.

As illustrated in FIGS. 1, 2, the connector 1 includes the housing 2, a front holder 3, a packing 4, and a plurality of terminals 5.

### 2. Housing

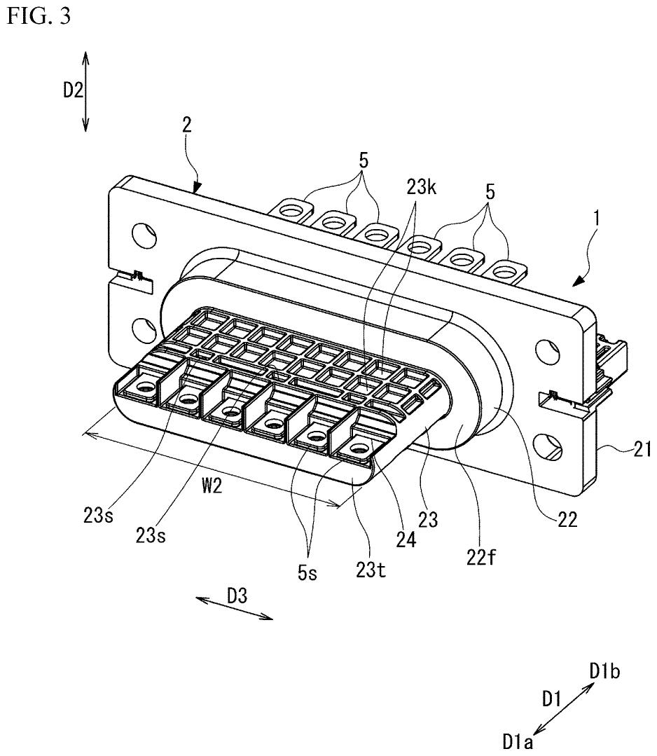

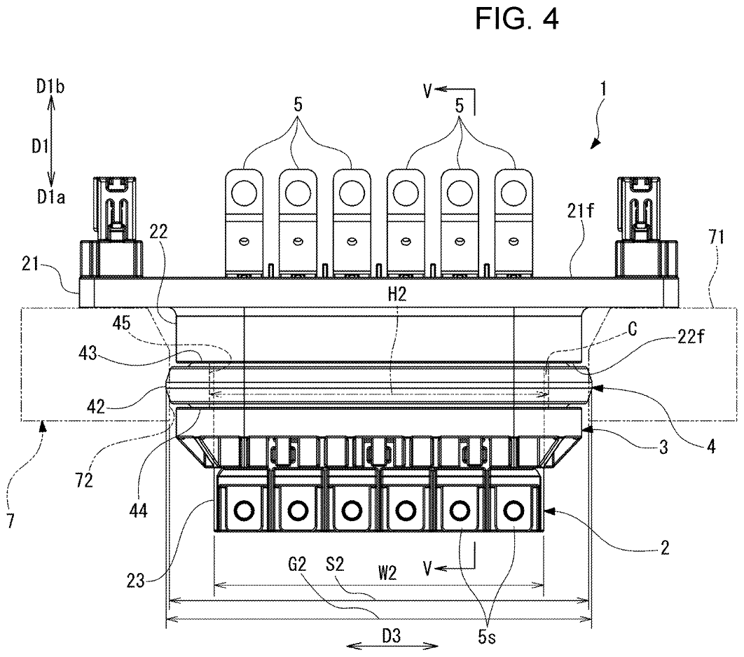

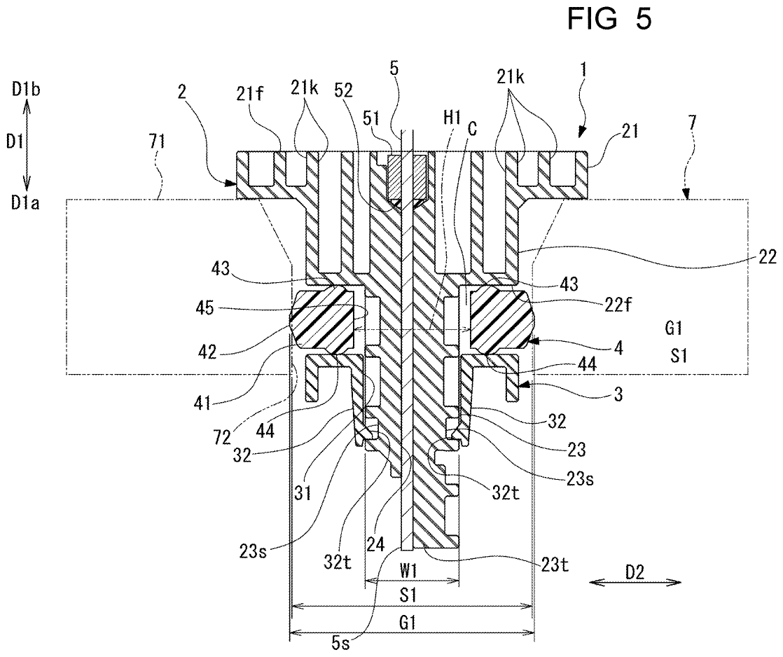

FIG. 3 is a perspective view of the housing of the connector according to the embodiment when viewed from the first side in the first direction. FIG. 4 is a view of the connector according to the embodiment when viewed from the second direction. FIG. 5 is a cross-sectional view taken along line V-V in FIG. 4.

The housing 2 holds the plurality of terminals 5. As illustrated in FIGS. 1 to 5, the housing 2 integrally includes a plate portion 21, the base portion 22, and the insertion portion 23. The housing 2 is made of a synthetic resin and has insulating properties.

The plate portion 21 is formed in a plate shape expanding along a plane intersecting the first direction D1. For example, the plate portion 21 is formed in a rectangular shape with the second direction D2 as a short side direction and the third direction D3 as a long side direction when viewed from the first direction D1. The shape of the plate portion 21 when viewed from the first direction is not limited to the rectangular shape, and may be an obround shape, a circular shape, a polygonal shape, or the like. As illustrated in FIG. 1, lightening recessed portions 21k for weight reduction are appropriately formed on a surface 21f facing the first side in the first direction D1 in the plate portion 21.

As illustrated in FIGS. 2 to 5, the base portion 22 is formed on the first side D1a in the first direction D1 with respect to the plate portion 21. The base portion 22 protrudes from the plate portion 21 to the first side D1a in the first direction D1. As illustrated in FIG. 3, the base portion 22 has an obround shape when viewed from the first direction D1, and is formed to be insertable into the connection opening 72. The base portion 22 has an end surface 22f facing the first side D1a in the first direction D1 at an end portion on the first side D1a in the first direction D1.

The insertion portion 23 is formed on the first side D1a in the first direction D1 with respect to the base portion 22. The insertion portion 23 protrudes from the base portion 22 to the first side D1a in the first direction D1. The insertion portion 23 has an obround shape when viewed from the first direction D1. An outer dimension of the insertion portion 23 is smaller than that of the base portion 22 when viewed from the first direction D1. The insertion portion 23 is formed such that the end surface 22f is exposed outside thereof when viewed from the first direction D1. The insertion portion 23 has, for example, a first width dimension W1 in the second direction D2 (see FIG. 5) and a second width dimension W2 in the third direction D3 (see FIG. 4). Lightening recessed portions 23k for weight reduction are appropriately formed on a surface of the insertion portion 23.

As illustrated in FIG. 5, the housing 2 has a plurality of terminal insertion holes 24 into which the plurality of terminals 5 can be inserted. Each of the terminal insertion holes 24 is formed to penetrate the plate portion 21, the base portion 22, and the insertion portion 23 of the housing 2 in the first direction D1. Each of the terminals 5 is made of metal and has conductivity. Each of the terminals 5 has a band plate shape extending in the first direction D1, and is inserted into each of the terminal insertion holes 24 via a collar 51 made of resin and a seal ring 52 made of rubber. Each of the terminals 5 is provided such that a distal end portion 5s on the first side D1a in the first direction D1 protrudes from each of the terminal insertion holes 24.

As illustrated in FIGS. 3, 5, a terminal support portion 23t is integrally formed at a distal end portion of the insertion portion 23 on the first side D1a in the first direction D1. The terminal support portion 23t is formed along the distal end portions 5s of the terminals 5 from a first side in the second direction D2, the distal end portions 5s of the terminals 5 protruding to the first side D1a in the first direction D1 from the terminal insertion holes 24.

### 3. Front Holder

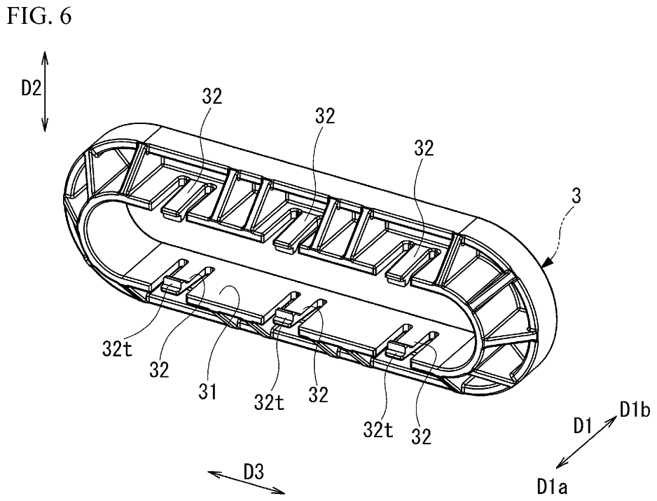

FIG. 6 is a perspective view of the front holder according to the embodiment when viewed from the first side in the first direction. As illustrated in FIGS. 4, 5, the front holder 3 is attached to the insertion portion 23 at a position away from the end surface 22f on the first side D1a in the first direction D1. The front holder 3 is made of a synthetic resin and has insulating properties. As illustrated in FIGS. 5, 6, the front holder 3 is formed in an annular shape having an obround shape when viewed from the first direction D1. The front holder 3 has an insertion hole 31 penetrating the front holder 3 in the first direction D1. The insertion hole 31 is formed in an obround shape when viewed in the first direction D1. The insertion portion 23 of the housing 2 is inserted into the insertion hole 31.

The front holder 3 includes locking claws 32 at a plurality of positions at intervals in a circumferential direction of the packing. Each of the locking claws 32 extends toward the first side D1a in the first direction D1, and integrally includes a locking protrusion (a position restricting portion) 32t at a distal end portion thereof. The locking protrusion 32t restricts relative movement of the front holder 3 with respect to the insertion portion 23 on the first side D1a in the first direction D1 in a state where the packing 4 is in contact with both the end surface 22f and the front holder 3. As illustrated in FIG. 5, the locking protrusion 32t of each of the locking claws 32 can be engaged with a locking recessed portion (a position restricting portion) 23s formed in the insertion portion 23. When the locking protrusion 32t is engaged with an end portion of the locking recessed portion 23s on the first side D1a in the first direction D1, the relative movement of the front holder 3 to the first side D1a in the first direction D1 with respect to the insertion portion 23 is restricted in the state where the packing 4 is in contact with both the end surface 22f and the front holder 3.

The locking recessed portions 23s extend along the first direction D1 by a predetermined length. As a result, the front holder 3 in which the locking protrusions 32t are located inside the locking recessed portions 23s is movable from a position where the locking protrusions 32t are engaged with the end portions of the locking recessed portions 23s on the first side D1a in the first direction D1 to the other side D1b in the first direction D1 within a range of the locking recessed portions 23s.

### 4. Packing

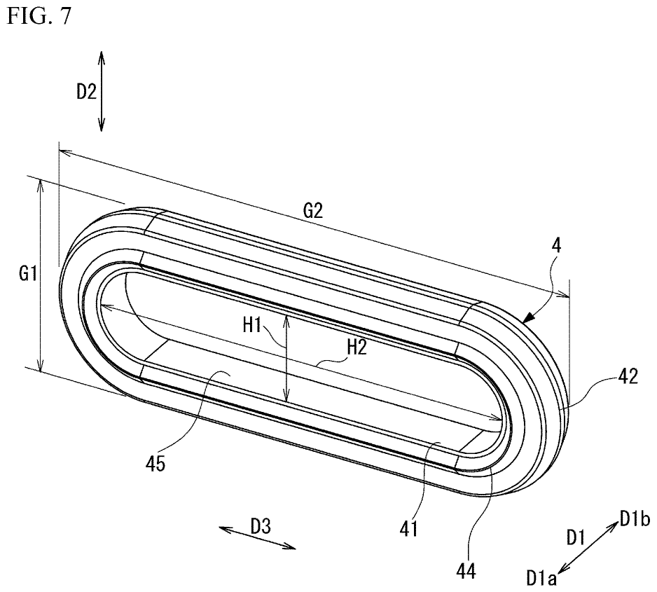

FIG. 7 is a perspective view of the packing according to the embodiment when viewed from the first side in the first direction.

As illustrated in FIGS. 4, 5, the packing 4 is disposed between the end surface 22f and the front holder 3. The packing 4 is made of a rubber material such as nitrile butadiene rubber (NBR) and has insulating properties. As illustrated in FIG. 7, the packing 4 is formed in an annular shape having an obround shape when viewed from the first direction D1. An insertion opening 45 penetrating the packing 4 in the first direction D1 is formed in the packing 4. The insertion opening 45 is formed in an obround shape when viewed in the first direction D1. As illustrated in FIGS. 4, 5, the insertion portion 23 of the housing 2 is inserted into the insertion opening 45.

The packing 4 integrally includes a main body portion 41, a first contact portion 42, a second contact portion 43, and a third contact portion 44. The main body portion 41 has, for example, a rectangular cross-sectional shape when viewed from the circumferential direction. The cross-sectional shape of the main body portion 41 may be, for example, a circular shape or the like.

The first contact portion 42 protrudes outward from the main body portion 41 in a direction intersecting the first direction D1. The first contact portion 42 protrudes outward in the second direction D2 and the third direction D3 from the main body portion 41. The first contact portion 42 protrudes outward in the directions intersecting the first direction D1 with respect to the insertion portion 23 and the front holder 3 when viewed from the first direction D1.

As illustrated in FIG. 5, an outer width dimension G1 of the first contact portion 42 of the packing 4 in the second direction D2 is larger than a first inner width dimension S1 of the connection opening 72 in the second direction D2. As illustrated in FIG. 4, an outer width dimension G2 of the first contact portion 42 of the packing 4 in the third direction D3 is larger than a second inner width dimension S2 of the connection opening 72 in the third direction D3. With this constitution, the first contact portion 42 of the packing 4 is in contact (close contact) with an inner peripheral surface of the connection opening 72 over an entire circumference in the circumferential direction.

As illustrated in FIG. 5, the insertion opening 45 has a first opening dimension H1 that is larger by a predetermined dimension than the first width dimension W1 of the insertion portion 23 in the second direction D2. Here, the first width dimension W1 is an outer dimension of the insertion portion 23 in the second direction D2 at a position facing the insertion opening 45 in the first direction D1. The first width dimension W1 may be, for example, a maximum dimension of the insertion portion 23 in the second direction D2 at the position facing the insertion opening 45 in the first direction D1. As illustrated in FIG. 4, the insertion opening 45 has a second opening dimension H2 that is larger by a predetermined dimension than the second width dimension W2 of the insertion portion 23 in the third direction D3. Here, the second width dimension W2 is an outer dimension of the insertion portion 23 in the third direction D3 at the position facing the insertion opening 45 in the first direction D1. The second width dimension W2 may be, for example, a maximum dimension of the insertion portion 23 in the third direction D3 at the position facing the insertion opening 45 in the first direction D1. With this constitution, a clearance C is formed between an inner peripheral surface of the insertion opening 45 of the packing 4 and an outer surface of the insertion portion 23 in a direction intersecting the first direction.

With this constitution, the packing 4 can be relatively displaced in a plane intersecting the first direction D1 within a range of the clearance C with respect to the insertion portion 23 of the housing 2. Therefore, the packing 4 allows positional displacement of the insertion portion 23 of the housing 2 in a plane intersecting the first direction D1 with respect to the connection opening 72 of the connection destination member 7 while maintaining a state where the first contact portion 42 is in contact with the inner peripheral surface of the connection opening 72 over the entire circumference in the circumferential direction.

As illustrated in FIGS. 4, 5, the second contact portion 43 protrudes from the main body portion 41 to the other side D1b in the first direction D1. The second contact portion 43 is in contact with the end surface 22f. The third contact portion 44 protrudes from the main body portion 41 to the first side D1a in the first direction D1. The third contact portion 44 is in contact with the front holder 3. In a state where the locking protrusions 32t of the front holder 3 are engaged with the locking recessed portions 23s of the insertion portion 23, the packing 4 is compressed in the first direction D1. With this constitution, the second contact portion 43 and the third contact portion 44 are in contact (close contact) with the end surface 22f and the front holder 3 over the entire circumference in the circumferential direction.

With this constitution, even when the front holder 3 moves relative to the insertion portion 23 in the first direction D1 within the range of the locking recessed portions 23s, the second contact portion 43 and the third contact portion 44 maintain the state of being in contact with the end surface 22f and the front holder 3.

### 5. Advantages

In the present embodiment, the packing 4 disposed between the end surface 22f of the housing 2 and the front holder 3 is included, and the first opening dimension H1 and the second opening dimension H2 of the insertion opening 45 are larger than the first width dimension W1 and the second width dimension W2 of the insertion portion 23. With this constitution, the clearance C is formed between the inner peripheral surface of the insertion opening 45 of the packing 4 and the outer surface of the insertion portion 23 in the direction intersecting the first direction. Therefore, the packing 4 can be relatively displaced in the plane intersecting the first direction D1 within the range of the clearance C with respect to the insertion portion 23 of the housing 2. As a result, while maintaining the state where the packing 4 is in contact with the inner peripheral surface of the connection opening 72 over the entire circumference in the circumferential direction, positional displacement of the insertion portion 23 of the housing 2 with respect to the connection opening 72 of the connection destination member 7 in the plane intersecting the first direction D1 is allowed. As a result, even when the positions of the connector 1 and the connection destination member 7 are displaced relative to each other, it is possible to maintain water-blocking performance.

In the present embodiment, the packing 4 integrally includes the first contact portion 42 in contact with the inner peripheral surface of the connection opening 72, the second contact portion 43 in contact with the end surface 22f, and the third contact portion 44 in contact with the front holder 3. With this constitution, the packing 4 easily comes into close contact with the housing 2, the front holder 3, and the connection destination member 7 over the entire circumference in the circumferential direction. As a result, it is possible to enhance water-blocking performance between the housing 2, the front holder 3, and the connection destination member 7.

In the present embodiment, the first contact portion 42 protrudes in the directions intersecting the first direction D1 with respect to the insertion portion 23 and the front holder 3 when viewed from the first direction D1. With this constitution, it is easy to bring the first contact portion 42 into contact with the inner peripheral surface of the connection opening 72 of the connection destination member 7 over the entire circumference of the packing 4.

In the present embodiment, the relative movement of the front holder 3 with respect to the insertion portion 23 in the first direction D1 is restricted in the state where the packing 4 is in contact with both the end surface 22f and the front holder 3. With this constitution, it is easy to maintain the state where the packing 4 is in contact with the housing 2 and the front holder 3 while allowing the relative movement of the front holder 3 with respect to the housing 2 in the first direction D1.

### 6. Modification

Next, several modifications will be described. Note that the constitutions of each of the modifications other than those described below are the same as those of the above-described embodiment.

In the above-described embodiment, the packing 4 includes the first contact portion 42, the second contact portion 43, and the third contact portion 44, but the present invention is not limited thereto. At least one of the first contact portion 42, the second contact portion 43, and the third contact portion 44 may be omitted.

In addition, in the above-described embodiment, the locking protrusions 32t formed on the front holder 3 and the locking recessed portions 23s are engaged with each other, so that the relative movement of the front holder 3 with respect to the insertion portion 23 in the first direction D1 is restricted, but the present invention is not limited thereto. For example, a locking protrusion may be formed on the insertion portion 23, and a locking recessed portion with which the locking protrusion is engaged may be formed in the front holder 3.

The several embodiments and modifications have been described above. However, the embodiments and the modifications are not limited to the above-described examples. For example, the plurality of embodiments may be implemented in combination with each other.

### INDUSTRIAL APPLICABILITY

According to one embodiment, it is possible to maintain water-blocking performance even when positions of the connector and the connection destination member are displaced relative to each other.

### REFERENCE SIGNS LIST

1 connector
2 housing
3 front holder
4 packing
5 terminal
7 connection destination member
22 base portion
22f end surface
23 insertion portion
23s locking recessed portion
31 insertion hole
32t locking protrusion
41 main body portion
42 first contact portion
43 second contact portion
44 third contact portion
45 insertion opening
72 connection opening
G1 outer width dimension (outer dimension)
G2 outer width dimension (outer dimension)
H1 first opening dimension (opening dimension)
H2 second opening dimension (opening dimension)
S1 first inner width dimension
S2 second inner width dimension
W1 first width dimension
W2 second width dimension

What is claimed is:

1. A connector comprising:
a housing that includes a base portion having an end surface facing a first side in a first direction, and an insertion portion that protrudes from the base portion to the first side in the first direction and is configured to be inserted into a connection opening formed in a connection destination member;
one or more terminals that are held by the housing;
a front holder that has an insertion hole into which the insertion portion is inserted, and is attached to the insertion portion at a position away from the end surface on the first side in the first direction; and
a packing that has an insertion opening into which the insertion portion is inserted, is disposed between the end surface and the front holder, and is in contact with an inner peripheral surface of the connection opening over an entire circumference in a circumferential direction of the packing,
wherein an opening dimension of the insertion opening in an intersecting direction intersecting the first direction is larger than an outer dimension, at a position facing the insertion opening in the first direction, of the insertion portion in the intersecting direction.

2. The connector according to claim 1, wherein
the packing includes:
a main body portion;
a first contact portion that protrudes from the main body portion in the intersecting direction and is in contact with the inner peripheral surface of the connection opening;
a second contact portion that protrudes from the main body portion to a second side in the first direction and is in contact with the end surface ; and
a third contact portion that protrudes from the main body portion to the first side in the first direction and is in contact with the front holder,
wherein the main body portion, the first contact portion, the second contact portion, and the third contact portion are integrated with each other.

3. The connector according to claim 2, wherein the first contact portion protrudes in the intersecting direction with respect to the insertion portion and the front holder when viewed from the first direction.

4. The connector according to claim 2, wherein the front holder further includes a locking protrusion engageable with the insertion portion so as to restrict relative movement of the front holder with respect to the insertion portion in the first direction in a state where the packing is in contact with both the end surface and the front holder.
